(19) United States
(12) Patent Application Publication
(10) Pub. No.: US 2004/0102178 A1
(43) Pub. Date: May 27, 2004

(54) Emergency backup communications system

(76) Inventor: John Williams, White Plains, NY (US)

Correspondence Address: Law Offices of Adam H. Jacobs, Suite 726, 1904 Farnam Street, Omaha, NE, 68102, US

(21) Appl. No.: 10/713,584

(22) Filed: Nov. 14, 2003

Related U.S. Application Data
(60) Provisional application No. 60/426,758, filed on Nov. 15, 2002.

(51) Int. Cl. H04H 1/00

(52) U.S. Cl. 455/404.1

(57) ABSTRACT

In combination, at least one public safety answering point operative to receive emergency communications from at least one local exchange carrier facility and an emergency backup communications system for facilitating emergency responses in the event of loss of communication and/or inoperability of the local public safety answering point. The emergency backup communications system includes a secondary central communications facility in generally independent and generally secure information transmission connection with the local exchange carrier facility, interface systems operative to receive and facilitate information reception from both automated location identification (ALI) systems and computer aided dispatch (CAD) systems. At least one operator is housed within the secondary central communications facility for receiving and screening the incoming emergency communications. Finally, a dispatch system is operative to interpret the information received via the interface systems and transmit dispatch information including location and response information to emergency response units.

### CROSS-REFERENCE TO RELATED PROVISIONAL PATENT

This application claims priority based on a provisional patent, specifically on the Provisional Patent Application Serial No. 60/426,758 filed Nov. 15, 2002.

### BACKGROUND OF THE INVENTION

1. Technical Field

The present invention is related to emergency communication systems and, more particularly, to a regional emergency backup communications system which includes redundant communication systems connecting a plurality of public safety answering points (PSAP) to at least one centralized operations command center which is designed to withstand both natural and man-made disasters to maintain generally continuous emergency communications regardless of the disaster scenario.

2. Description of the Prior Art

At the present time, the approach to emergency communication across the country is a cobbled-together web of already-available communications networks which offer highly-variable levels of service in an actual emergency. Further, these networks are generally standalone installations that are not interconnected, are not subject to nationally-consistent standard operating procedures and are not required to utilize consistent or compatible technologies. For example, in large cities where the emergency communications network is used frequently, the emergency communications network is modernized and very reliable. On the other hand, in rural areas and smaller towns, the emergency communications network is not as critical to the functionality of the town and therefore may be outdated and unreliable. Given the fact that disasters occur in all areas of the country, this haphazard communication web has the potential to exacerbate any disaster situation as opposed to offering a solution or remedy therefor. In fact, the telephone communication systems currently in place can be woefully inadequate during emergencies and disasters for providing communication between citizens and emergency personnel, as these telephone systems are prone to overload and failure due to line integrity disruptions. It has been found that the telephone communication system is very often one of the first infrastructure systems to be rendered inoperable during a disaster. When such an interruption occurs, it suddenly becomes virtually impossible to receive emergency help calls at the primary PSAP which serves to coordinate the emergency response in the regional area. There is therefore a need for a communication system and backup PSAP which will permit management of the emergency situation regardless of the status of the primary PSAP.

The situation that often occurs in connection with emergency scenarios is that the primary PSAP is overloaded with calls from citizens regarding the disaster. With the organization of the phone system comprising a local telephone carrier exchange central office with numerous branches extending outwards therefrom, it is most likely that communication between individuals and the local telephone carrier exchange central office will continue during a disaster while the connection between the local telephone carrier exchange central office and the PSAP becomes overloaded, thus preventing calls from being received at the PSAP. When the phone system overloads, communication between the PSAP and the local telephone carrier exchange central office is disrupted and it has been found that the majority of 911 facilities in the country do not have adequate backup communication systems to overcome such a disruption. In fact, it is not commercially feasible in all but the largest metropolitan areas to include such a backup system and therefore in the majority of situations, when the connection between the local telephone carrier exchange central office and the PSAP fails, no further communications with the citizenry is possible. There is therefore a need for an emergency communications backup system which will permit continued communication with the citizenry during times of emergency.

Therefore, an object of the present invention is to provide an improved emergency communications backup system.

Another object of the present invention is to provide an emergency communications backup system which includes a generally independent and secure communications system which functions independent of the standard communications web to ensure communications operation post-disaster.

Another object of the present invention is to provide an emergency communications backup system which can respond to regional disasters in a coordinating manner over and above the responses of the individual PSAPs.

Another object of the present invention is to provide an emergency communications backup system which can be used to supplement the existing emergency response communications web thereby providing needed backup for the system which is not available at present.

Another object of the present invention is to provide an emergency communications backup system which will respond to local emergency requests in the same manner as would be performed by the local PSAP to keep the in-place emergency response system as intact as possible during times of extreme duress.

Finally, an object of the present invention is to provide an emergency communications backup system which is efficient, safe and durable in use.

### SUMMARY OF THE INVENTION

The present invention provides, in combination, at least one public safety answering point operative to receive emergency communications from at least one local exchange carrier facility and dispatch emergency response units in response to receipt of the emergency communications and an emergency backup communications system for facilitating emergency responses in the event of loss of communication and/or inoperability of the at least one local public safety answering point. The emergency backup communications system includes a secondary central communications facility in generally independent and generally secure information transmission connection with the local exchange carrier facility. The system further includes an automated location identification interface system operative to receive and facilitate information reception from an automated location identification (ALI) system associated with the local exchange carrier facility and a computer aided dispatch interface system operative to receive and facilitate information reception from a computer aided dispatch (CAD) system associated with the local exchange carrier facility. At least one operator is housed within the secondary central communications facility, the operator being trained to receive incoming emergency communications and screen the incoming emergency communications for location and response information. Finally, a dispatch system housed within the secondary central communications facility is operative to interpret the information received via the automated location identification interface system and the computer aided dispatch interface system and transmit dispatch information including location and situation information to emergency response units for response to incoming emergency communications from the local exchange carrier facility.

The emergency backup communications system as thus described clearly offers several advantages over those systems found in the prior art. For example, particularly in light of the 9/11 tragedy and the potential for terrorist attacks at any time and at any place, there is no guarantee that the present 911 system will be able to deal with the aftermath of such an attack, and at the present time there is no backup communication system dedicated to emergency response. Furthermore, because the communications system of the present invention is generally independent and secure as compared to the standard communication network used by the PSAP, the chances are far greater that the communications network of the present invention will survive a catastrophe intact enabling continuous communication between members of the afflicted public and the rescue and emergency workers who are trying to assist them. Also, the emergency backup communications system of the present invention is designed for use with both military and civil communications systems on all levels, including local, state and federal governmental entities which means that the present invention is a macrosystem in that it is designed to coordinate emergency response not only locally, but regionally and nationally if necessary. The present invention thus provides a substantial improvement over those systems found in the prior art.

### BRIEF DESCRIPTION OF THE DRAWINGS

FIG. 1 is a flow diagram showing the general system description of the emergency backup communications system of the present invention;

FIG. 2 is a flow diagram showing the normal operation of a 911 emergency response system during a typical emergency;

FIG. 3 is a flow diagram illustrating the operation of the emergency backup communications system of the present invention when the primary 911 system is inoperable; and

FIG. 4 is an illustration of the potential services of the emergency backup communications system of the present invention.

### DESCRIPTION OF THE PREFERRED EMBODIMENT

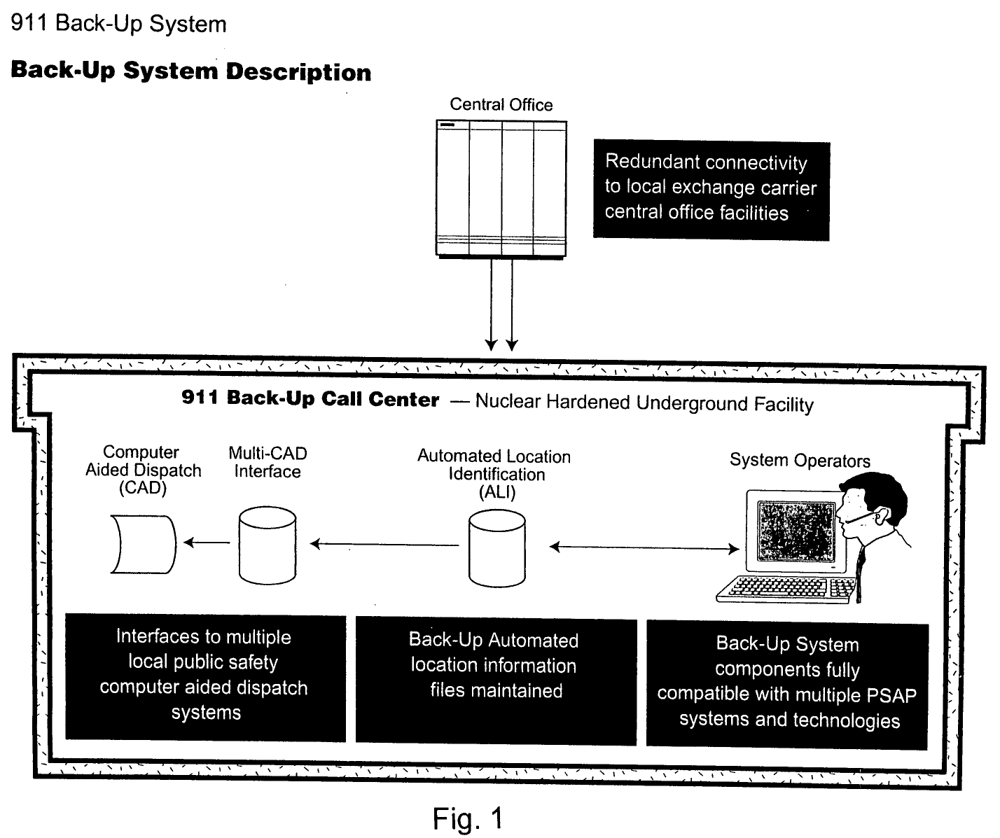

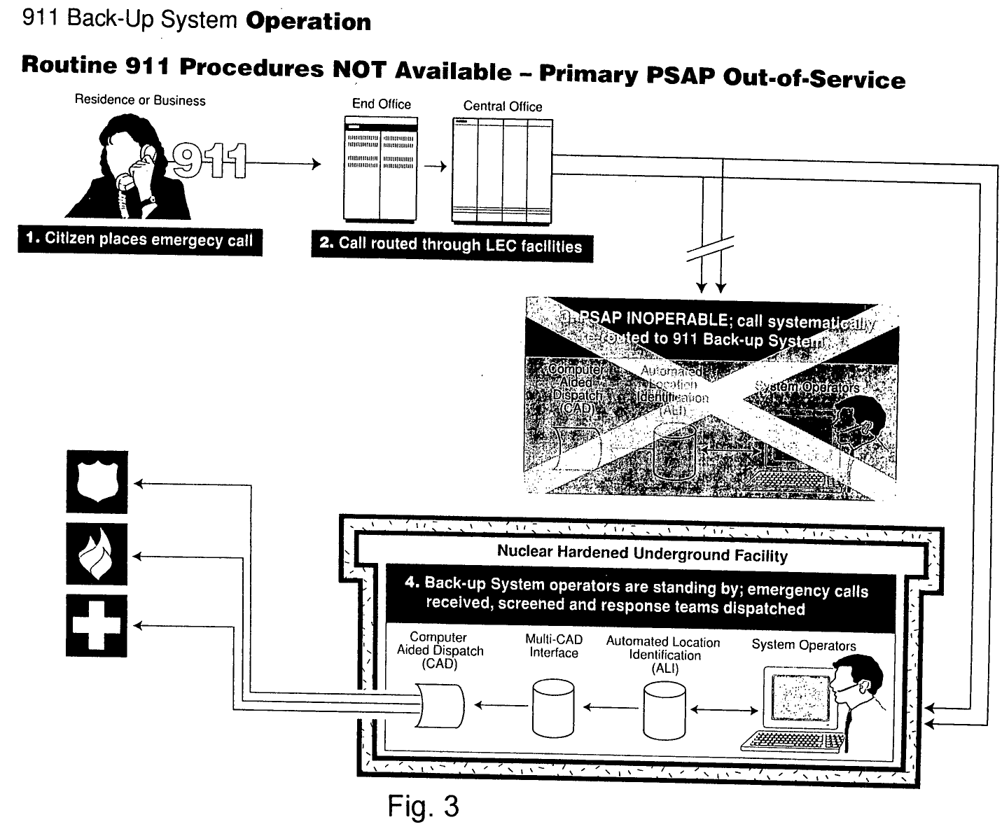

The emergency backup communications system of the present invention is shown best in FIGS. 1 and 3 as providing a “safety net” for 911 systems currently in operation. At the present time, the approach to emergency communication across the country is a cobbled-together web of already-available communications networks which offer highly-variable levels of service in an actual emergency. Further, these networks are generally standalone installations that are not interconnected, are not subject to nationally-consistent standard operating procedures and are not required to utilize consistent or compatible technologies. For example, in large cities where the emergency communications network is used frequently, the emergency communications network is modernized and very reliable. On the other hand, in rural areas and smaller towns, the emergency communications network is not as critical to the functionality of the town and therefore may be outdated and unreliable. Given the fact that disasters occur in all areas of the country, this haphazard communication web has the potential to exacerbate any disaster situation as opposed to offering a solution or remedy therefor. In fact, the telephone communication systems currently in place can be woefully inadequate during emergencies and disasters for providing communication between citizens and emergency personnel, as these telephone systems are prone to overload and failure due to line integrity disruptions. It has been found that the telephone communication system is very often one of the first infrastructure systems to be rendered inoperable during a disaster. When such an interruption occurs, it suddenly becomes virtually impossible to receive emergency help calls at the primary PSAP which serves to coordinate the emergency response in the regional area. There is therefore a need for a communication system and backup PSAP which will permit management of the emergency situation regardless of the status of the primary PSAP.

The situation that often occurs in connection with emergency scenarios is that the primary PSAP is overloaded with calls from citizens regarding the disaster. With the organization of the phone system comprising a local telephone carrier exchange central office with numerous branches extending outwards therefrom, it is most likely that communication between individuals and the local telephone carrier exchange central office will continue during a disaster while the connection between the local telephone carrier exchange central office and the PSAP becomes overloaded, thus preventing calls from being received at the PSAP. When the phone system overloads, communication between the PSAP and the local telephone carrier exchange central office is disrupted and it has been found that the majority of 911 facilities in the country do not have adequate backup communication systems to overcome such a disruption. In fact, it is not commercially feasible in all but the largest metropolitan areas to include such a backup system and therefore in the majority of situations, when the connection between the local telephone carrier exchange central office and the PSAP fails, no further communications with the citizenry is possible. There is therefore a need for an emergency communications backup system which will permit continued communication with the citizenry during times of emergency.

The emergency backup communications system of the present invention would include at its core a main national headquarters which is located in a facility with comprehensive military-style protection and security from all forms of disaster and threats including but not limited to physical, electronic, chemical, biological, nuclear and radiological events, thus rendering the main national headquarters generally impervious to all but the most exceptional disaster. Although such a headquarters may be located in any appropriate community, it is preferred that the headquarters be centrally located in the United States in an area of the country which is not earthquake-prone in order to insure the integrity of the headquarters. It has been found that the Omaha, Nebr. metropolitan area offers an exceptionally well-located and well-prepared metropolitan community for such a headquarters, although it is to be expected that numerous regional command centers would be located in metropolitan areas around the country, each of which would be in guaranteed communications via the redundant communication systems with the main headquarters to ensure coordinated response in the event of a disaster regardless of the location around the country. The main headquarters would utilize backbone communications trunks, including landline, fiber optic, microwave, UHF and VHF broadcasting facilities and other radio and satellite technologies to maintain communication between the main headquarters and regional headquarters and local exchange carrier central office facilities. It should be noted that the term “redundant” as used in this disclosure refers to these multiple backup communication systems, and not in merely a general way to the currently available 911 systems. This broad array of communications infrastructure exists (in many ways, uniquely) in the Omaha, Nebr. metropolitan area. Of course, it is preferred that the regional command centers each be protected in a facility similar to that used in connection with the main national headquarters with comprehensive military-style protection and security from all forms of disaster and threats including but not limited to physical, electronic, chemical, biological, nuclear and radiological events, thus rendering the regional headquarters generally impervious to all but the most exceptional disaster. One way to envision the main and regional headquarters system is to think of it as a “hub and spoke” system, with the main headquarters in communications connection with each of the regional headquarters and each of the regional headquarters in communications connection with the local telephone exchanges and PSAPs, although it should be noted that some direct connections between the main headquarters and local telephone exchanges and PSAPs may be desirable to ensure continuous emergency connections.

It is important to note that the emergency backup communications system of the present invention is intended to supplement those 911 systems already in existence around the country but which, for various reasons, cannot be updated or made redundant. The main headquarters will be staffed and operated twenty-four hours a day, seven days a week, in order to be available for any disaster occurrence and in any situation. It is expected that the call center staff will be highly trained and familiar with the locations to which they are assigned in order to insure proper and quick response to any incoming call. This training is especially critical in connection with the present invention as the emergency backup communications system of the present invention will likely be used only in the event of severe emergency where a disaster has crippled the existing 911 system to such an extent that the emergency backup communications system must be employed. Therefore, the individuals staffing the main headquarters and, for that matter, the regional headquarters, must be highly trained, highly competent, and highly motivated to decisively enact emergency responses in dire circumstances.

At the heart of the present inventions are the redundant communication systems, facilities, and technologies which connect the main headquarters and regional headquarters to existing PSAPs and local telephone carrier exchange central offices, thus providing seamless connectivity in the event that one or more primary PSAPs become inoperable or destroyed. The emergency backup communications system of the present invention includes interfaced technologies which permit the main headquarters and the regional headquarters to connect with a variety of local computer-aided dispatch systems (CAD), as well as various technologies to insure compatibility with automated location identification systems (ALI), each of which are currently used by 911 systems in operation at this time. However, it is important to note that as there is not a universal CAD or ALI system used by each and every one of the 911 systems currently in operation, an important component of the present invention is the ability to interface with the different CAD and ALI systems currently being used in the emergency response field to ensure that communication between the local telephone exchanges and PSAPs is maintained.

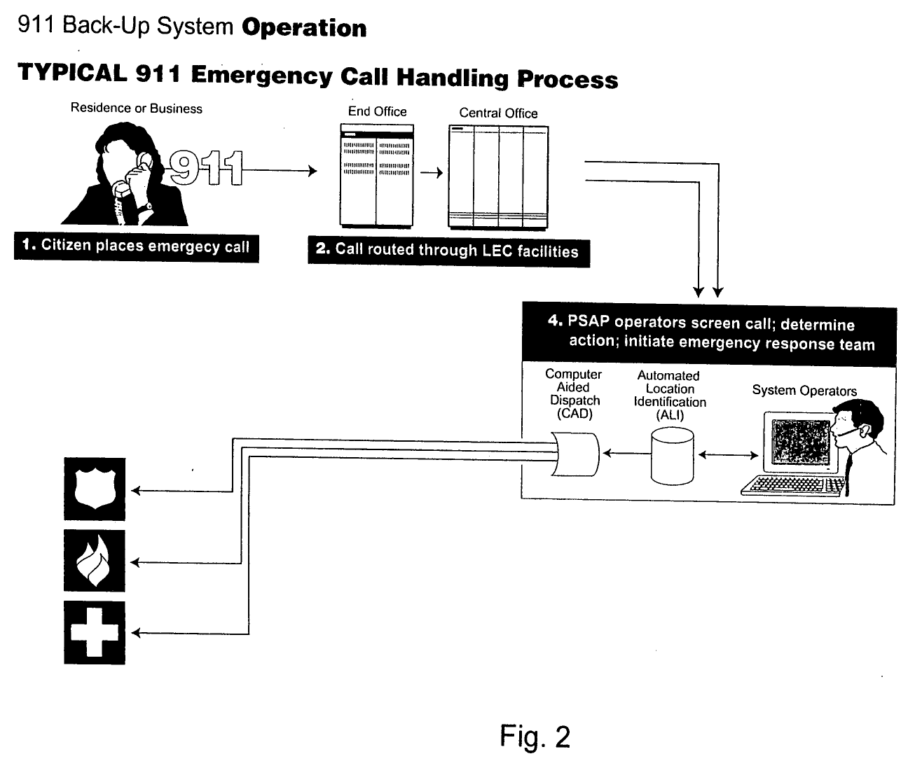

FIG. 2 illustrates a typical 911 emergency call handling process. As can be seen, once the citizen places an emergency call from a residence or business or cellular phone, the call is routed through local telephone exchange carrier facilities such as an end office and then into a central office where the call is routed to the PSAP call center. It should be noted that in the vast majority of situations, these emergency calls are routed over standard telephone lines which remain susceptible to disruption due to disaster. Once the PSAP receives the emergency call, the PSAP operators determine the appropriate action and initiate the emergency response by contacting emergency response personnel. This is typically done through the implemented CAD and ALI systems which identify the location of the emergency response unit and dispatch the unit to the emergency call, be it police, fire, or paramedic emergency dispatch. The question is, what occurs when communication between the citizen and PSAP is disrupted? The answer is, absent a redundant backup system as disclosed in the present invention, nothing. No response to an emergency can be dispatched as the local 911 operator is unaware of the occurrence of the emergency.

The emergency backup communications system of the present invention is shown in operation in FIG. 3. In this scenario, the citizen would place the emergency call which is routed through the local exchange carrier facilities and which is attempted to be routed to the PSAP call center. The PSAP call center, however, is unable to be contacted due to communications lines being down or the PSAP center being disables or destroyed. The call is automatically rerouted to the emergency backup communications system of the present invention which would travel either to a local or regional emergency backup communications system headquarters, or directly to the main backup system headquarters via secure and redundant communication systems. Each of the local exchange carriers connected to the emergency backup communications system of the present invention would be connected via redundant communication systems such as landline, fiber optic, microwave, and other radio and satellite technologies, each of which would function in turn to ensure the connection between the local exchange carrier and the emergency backup communications system. As the emergency call is received at the regional or national headquarters of the emergency backup communications system, the emergency operator would screen the call and immediately contact local emergency response teams available in the area of the citizen placing the emergency call and dispatch them via the CAD and ALI systems as previously described. One major difference between the CAD and ALI systems currently being used with 911 systems and the CAD and ALI systems proposed for use with the present invention is that the regional or nationwide nature of the emergency backup communications system of the present invention permits the dispatch of emergency units to the emergency call even if such units are not specifically connected with the primary PSAP which was disconnected or destroyed. Of course, the appropriate local emergency unit would be dispatched based on availability, but it is an improvement of the present invention over the 911 systems currently found under the prior art that emergency response is not restricted to those units connected with the destroyed primary PSAP. Furthermore, the national and regional headquarters would have multiple CAD interfaces which permit communication with all of the emergency vehicles and teams available for response in the area of the disaster, be it police, fire or paramedic. The emergency backup communications system of the present invention would remain on line until such time as the primary PSAP is restored, at which time control of the emergency situation would be passed back to the primary PSAP and the emergency backup communications system of the present invention would resume its intended backup functionality.

An important feature of the present invention is that the emergency backup communications system is designed for use with both military and civil communications systems on all levels, including local, state and federal governmental entities. A major problem with current 911 systems is that they are not designed to communicate with other agencies, and thus emergency response capability is compromised. The critical difference between current 911 facilities and the emergency backup communications system of the present invention is that the 911 facilities are microsystems, in that they are only designed and used with specific local emergency response teams, whereas the present invention is a macrosystem in that it is designed to coordinate emergency response not only locally, but regionally and nationally if necessary. Local 911 may be unaware of the various federal agencies available to them in an emergency, including such agencies as the Center for Disease Control, the Federal Emergency Management Agency, Homeland Security and the various branches of the military, including the National Guard. In fact, the present invention is designed specifically for use in connection with the recently enacted Homeland Defense initiatives which are designed to deal with the results of terrorist attacks, including bioterrorism and other weapons of mass destruction. Current 911 systems are not designed to deal with large-scale disasters, and the likelihood that these systems will overload and fail in such a situation is very high. The emergency backup communications system of the present invention is specifically designed to facilitate such interorganizational cooperation in an emergency situation, and thus presents a substantial improvement over the current 911 systems in use.

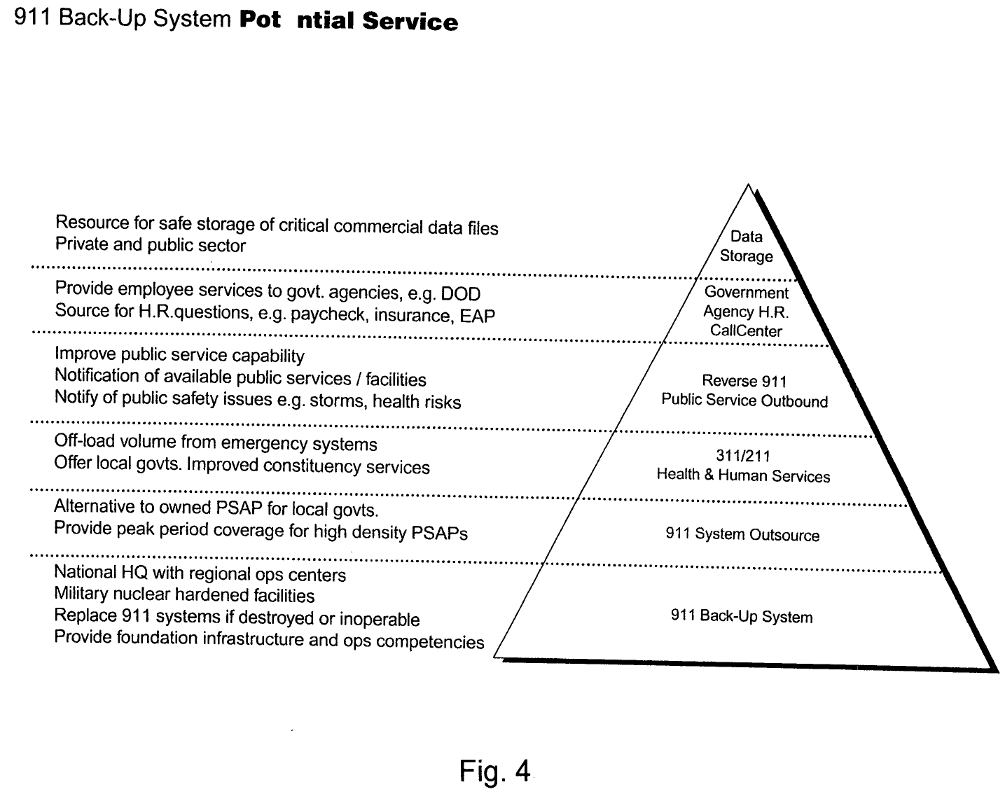

It is further expected that the emergency backup communications system of the present invention will be used for other applications in which a redundant alternative communication system capable of operating under extreme conditions is necessary. FIG. 4 illustrates some of the expected and potential services along with their expected benefits. Several scenarios are envisioned, including the emergency backup communications system of the present invention providing outsource 911 services for communities which, for one reason or another, are unable to design, build, install, or maintain the necessary emergency response systems. The economies of scale often dictate that smaller communities cannot afford stand-alone dedicated PSAP facilities and it is an intended function of the present invention to provide emergency response facilities for the smaller communities in which incoming 911 calls would be routed to the regional or national headquarters of the emergency backup communications system of the present invention and appropriate emergency responses would be dispatched by the emergency backup communications system operators on the local scale to the person or persons making the 911 call. Alternatively, the emergency backup communications system of the present invention is usable to provide overflow capability to the PSAPs of larger communities or communities that maintain PSAPs for minimal call volumes. The emergency backup communications system of the present invention would be engaged upon reaching the overflow threshold and would be available for increased call volume to ensure that all calls are dealt with speedily and correctly.

Another potential use of the present invention is in connection with non-emergency community service communications which many communities would provide but are unable to do so due to the cost of the dedicated information source. Such communications are often referred to as 311/211 calls, which generally deal with health and human services calls. These calls are inquires by citizens related to use of public assistance related to homeless and other shelter facilities, availability of medical services, tax and licensing requirements as well as other such community-related informational communications. With a modicum of training and automated system-generated scripts to standardize call response and increase efficiency, the emergency backup communications system of the present invention can be adapted to provide such services and would serve as a call center and information clearing house for the community. The 24/7 nature of the emergency backup communications system of the present invention would provide far better service than the currently available 311 and 211 call systems, and would cost communities far less as the overall cost would be divided between multiple communities.

Another scenario in which the emergency backup communications system of the present invention will be usable is in connection with pre-recorded outbound calls of public service nature. This scenario would be referred to as a “reverse 911 call” and the emergency backup communications system of the present invention would be used to initiate recorded outbound calls making announcements such as, for example, the availability of new or existing community facilities, e.g. swimming pool seasonal opening/closing, announce voting location hours/procedures as well as notification of potential safety threats including pending storms, toxic spills or virus threats. Again, with only minor modifications, the emergency backup communications system of the present invention is usable in such a situation due to the adaptability and protected communications provided thereby.

Finally, the emergency backup communications system of the present invention is usable as a call center to serve the Human Resource needs of government agencies. Initially, large international agencies such as the Department of Defense could provide HR related services to their employees on a 24/7 basis accessible from any location in the world. The emergency backup communications system of the present invention is adaptable to address questions related to paychecks, benefits and employee assistance programs. The instantaneous response capability of the emergency backup communications system of the present invention permits the user to access information regardless of the time and location of the origination of the call, and thus provides a significant service improvement over those systems found in the prior art.

Of course, it is to be understood that numerous modifications, substitutions and additions may be made to the emergency backup communications system described herein. For example, the exact implemented features and functional characteristics of the features described above may be changed or modified so long as the intended functionality of providing a redundant emergency backup communications system is maintained. Additionally, the precise location and characteristics of the headquarters described herein may be changed or modified so long as the functionality of the headquarters, be it local, regional or national, is not impaired. Finally, modification of the communication systems based on improved technology expected and will not affect the functionality of the disclosure contained herein.

There has thus been shown and described an emergency backup communications system which fulfills all of its intended purposes.

I claim:

1. In combination:
at least one public safety answering point operative to receive emergency communications from at least one local exchange carrier facility and dispatch emergency response units in response to receipt of said emergency communications; and
an emergency backup communications system for facilitating emergency responses in the event of loss of communication and/or inoperability of said at least one local public safety answering point, said emergency backup communications system including;
a secondary central communications facility in generally independent and generally secure information transmission connection with said at least one local exchange carrier facility;
automated location identification interface means operative to receive and facilitate information reception from an automated location identification (ALI) system associated with said at least one local exchange carrier facility;
computer aided dispatch interface means operative to receive and facilitate information reception from a computer aided dispatch (CAD) system associated with said at least one local exchange carrier facility;
at least one operator in said secondary central communications facility operative to receive incoming emergency communications and screen said incoming emergency communications for location and response information;
dispatch means in said secondary central communications facility operative to interpret said information received via said incoming emergency communications, said automated location identification interface means and said computer aided dispatch interface means and transmit dispatch information including said location and response information to emergency response units for response to incoming emergency communications from said at least one local exchange carrier facility.

2. The combination of claim 1 wherein said secondary central communications facility is generally impervious to externally-based operational disruptions to facilitate generally uninterruptible emergency communications with local exchange carrier facilities and emergency response units thereby generally ensuring uninterrupted emergency response to emergency situations which have disabled a public safety answering point.

3. The combination of claim 1 wherein said automated location identification interface means and said computer aided dispatch interface means each include programmable computing means operative to receive emergency communications data from an automated location identification (ALI) system and a computer aided dispatch (CAD) system associated with said at least one local exchange carrier facility and identify and interpret the incoming emergency communications data and output recognizable location and response information independent of the specific automated location identification (ALI) system and a computer aided dispatch (CAD) system from which said emergency communications data is received.

4. The combination of claim 1 further comprising communications means operative to interface with both military and civil communications systems to facilitate interorganizational communications thereby acting as a macrosystem.

5. The combination of claim 1 wherein said at least one operator is at least one highly trained individual.

6. The combination of claim 1 wherein said generally independent and generally secure information transmission connection between said at least one local exchange carrier facility and said secondary central communications facility is selected from the group comprising landline, fiber optic, microwave, radio communications, satellite communications and cable.

7. An emergency backup communications system for facilitating emergency responses in the event of loss of communication and/or inoperability of a public safety answering point, said emergency backup communications system comprising:
a secondary central communications facility in generally independent and generally secure information transmission connection with a local exchange carrier facility;
automated location identification interface means operative to receive and facilitate information reception from an automated location identification (ALI) system associated with a local exchange carrier facility;
computer aided dispatch interface means operative to receive and facilitate information reception from a computer aided dispatch (CAD) system associated with a local exchange carrier facility;
at least one operator in said secondary central communications facility operative to receive incoming emergency communications and screen said incoming emergency communications for location and response information;
dispatch means in said secondary central communications facility operative to interpret said information received via said incoming emergency communications, said automated location identification interface means and said computer aided dispatch interface means and transmit dispatch information including location and situation information to emergency response units for response to incoming emergency communications from a local exchange carrier facility; and
said secondary central communications facility being generally impervious to externally-based operational disruptions to facilitate generally uninterruptible emergency communications with local exchange carrier facilities and emergency response units thereby generally ensuring uninterrupted emergency response to emergency situations which have disabled a public safety answering point.

8. The emergency backup communications system of claim 7 wherein said automated location identification interface means and said computer aided dispatch interface means each include programmable computing means operative to receive emergency communications data from an automated location identification (ALI) system and a computer aided dispatch (CAD) system associated with said at least one local exchange carrier facility and identify and interpret the incoming emergency communications data and output recognizable location and response information independent of the specific automated location identification (ALI) system and a computer aided dispatch (CAD) system from which said emergency communications data is received.

9. The emergency backup communications system of claim 7 further comprising communications means operative to interface with both military and civil communications systems to facilitate interorganizational communications thereby acting as a macrosystem.

10. The emergency backup communications system of claim 7 wherein said at least one operator is at least one highly trained individual.

11. The emergency backup communications system of claim 7 wherein said generally independent and generally secure information transmission connection between said at least one local exchange carrier facility and said secondary central communications facility is selected from the group comprising landline, fiber optic, microwave, radio communications, satellite communications and cable.

12. A method of providing an emergency backup communications system for facilitating emergency responses in the event of the nonfunctionality of a public safety answering point, said method comprising the steps:
providing a secondary central communications facility in generally independent and generally secure information transmission connection with a local exchange carrier facility, said secondary central communications facility being generally impervious to externally-based operational disruptions to facilitate generally uninterruptible emergency communications with local exchange carrier facilities and emergency response units;
providing an automated location identification interface means operative to receive and facilitate information reception from an automated location identification (ALI) system associated with a local exchange carrier facility;
providing a computer aided dispatch interface means operative to receive and facilitate information reception from a computer aided dispatch (CAD) system associated with a local exchange carrier facility;
determining that the public safety answering point is nonfunctional;
substituting said secondary central communications facility and said generally independent and generally secure information transmission connection for the nonfunctional public safety answering point;
receiving incoming emergency communications via said generally independent and generally secure information transmission connection within said secondary central communications facility from a local exchange carrier facility;
screening said incoming emergency communications for location and response information;
interpreting said location and response information via said incoming emergency communications, said automated location identification interface means and said computer aided dispatch interface means such that the location and response for the emergency situation is determined; and
transmitting dispatch information including said location and response information to emergency response units for response to incoming emergency communications from a local exchange carrier facility.
